(19) United States
(12) Patent Application Publication
(10) Pub. No.: US 2026/0003051 A1
(43) Pub. Date: Jan. 1, 2026

(54) WIFI RADAR CONTROL METHOD AND WIFI RADAR COMMUNICATION CIRCUIT

(71) Applicant: Realtek Semiconductor Corporation, Hsinchu (TW)

(72) Inventors: Cho-Han YU, Hsinchu (TW); Shau-Yu CHENG, Hsinchu (TW); Wen-Yung LEE, Hsinchu (TW)

(21) Appl. No.: 19/250,083

(22) Filed: Jun. 26, 2025

Related U.S. Application Data
(60) Provisional application No. 63/665,255, filed on Jun. 28, 2024.

(30) Foreign Application Priority Data
May 19, 2025 (TW) 114118720

(51) Int. Cl. G01S 13/02; G01S 13/90

(52) U.S. Cl. CPC G01S 13/02; G01S 13/9023

(57) ABSTRACT

A WiFi radar control method includes following steps. In a first radar transceiving slot, first radar frames are sequentially transmitted, and first reflections corresponding to the first radar frames are received. Waveforms of the first reflections are analyzed to determine whether the first radar frames are subject to interference. When interference is detected in the first radar frames, a retry count is incremented. When the retry count is not zero, at least one retry radar frame is transmitted in the first radar transceiving slot or in a second radar transceiving slot following the first radar transceiving slot.

### RELATED APPLICATIONS

This application claims the priority benefit of U.S. Provisional Application Ser. No. 63/665,255, filed Jun. 28, 2024, and Taiwan Application Serial Number 114118720, filed May 19, 2025, which are herein incorporated by reference.

### BACKGROUND

### Field of Invention

The disclosure relates to a WiFi radar control method and a WiFi radar communication circuit, and more particularly, to a control method for transmitting retry frames when WiFi radar signals are subject to interference.

### Description of Related Art

WiFi radar technology employs the reflective, scattering, and diffractive properties of wireless signals for sensing, similar to conventional radar. Unlike traditional radar systems, WiFi radar eliminates the need for additional radar transmission hardware by utilizing existing WiFi transceiver circuitry. This allows for the transmission of radar signals to detect environmental changes and target motion primarily using the original WiFi hardware. However, these transmitted radar frames are vulnerable to environmental interference (such as competition from other WiFi signals, interference from Bluetooth communications, and multipath effects). Therefore, a key challenge in WiFi radar technology is to overcome signal interference and maintain a sufficient count of valid frames within each sensing period.

### SUMMARY

An embodiment of the disclosure provides a WiFi radar control method comprising the following steps. In a first radar transceiving slot, a plurality of first radar frames are sequentially transmitted, and a plurality of first reflection echoes corresponding to the plurality of first radar frames are received. Based on waveforms of the plurality of first reflection echoes, it is determined whether the plurality of first radar frames are subject to interference. In response to determining that the plurality of first radar frames are subject to interference, a retry count is incremented. In response to the retry count not being zero, at least one retry radar frame is transmitted in the first radar transceiving slot or in a second radar transceiving slot subsequent to the first radar transceiving slot.

Another embodiment of the disclosure provides a WiFi radar control method includes the following steps. In a radar transceiving slot, a radar frame is transmitted and a reflection echo corresponding to the radar frame is received. Based on a waveform of the reflection echo, it is determined whether the radar frame is subject to interference. In response to determining that the radar frame is not subject to interference, a target frame count is decremented. In response to the target frame count not being zero, another radar frame continues to be transmitted in the radar transceiving slot.

Another embodiment of the disclosure provides a WiFi radar communication circuit including an analog front-end circuit and a control unit. The analog front-end circuit is coupled to a transmitting antenna and a receiving antenna, and the analog front-end circuit is configured to control the transmitting antenna and the receiving antenna to operate in a WiFi communication band or a radar transceiving band. The control unit is coupled to the analog front-end circuit. The control unit is configured to: in a first radar transceiving slot, sequentially transmit, via the analog front-end circuit, a plurality of first radar frames to the transmitting antenna, and receive, from the receiving antenna, a plurality of first reflection echoes corresponding to the plurality of first radar frames; determine, based on waveforms of the plurality of first reflection echoes, whether the plurality of first radar frames are subject to interference; in response to determining that the plurality of first radar frames are subject to interference, increment a retry count; and in response to the retry count not being zero, transmit at least one retry radar frame in the first radar transceiving slot or in a second radar transceiving slot subsequent to the first radar transceiving slot.

It is to be understood that both the foregoing general description and the following detailed description are by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a WiFi radar communication circuit according to some embodiments of the present disclosure.

FIG. 2A and FIG. 2B are flowchart diagram illustrating a WiFi radar control method according to some embodiments of the present disclosure.

FIG. 3A is a schematic diagram illustrating a first embodiment where radar frames in a first radar transceiving slot and a second radar transceiving slot do not encounter interference.

FIG. 3B is a schematic diagram illustrating a second embodiment in which some radar frames in the first radar transceiving slot encounter interference, and radar frames in the second radar transceiving slot do not encounter interference.

FIG. 3C is a schematic diagram illustrating a third embodiment that some radar frames in the first radar transceiving slot and the second radar transceiving slot encounter interference.

FIG. 4 is a flowchart illustrating a WiFi radar control method according to some embodiments of the present disclosure.

FIG. 5A is a schematic diagram illustrating a fourth embodiment that radar frames in a radar transceiving slot do not encounter interference.

FIG. 5B is a schematic diagram illustrating a fifth embodiment that some radar frames in the radar transceiving slot encounter interference.

FIG. 5C is a schematic diagram illustrating a sixth embodiment that some radar frames in the radar transceiving slot encounter interference.

### DETAILED DESCRIPTION

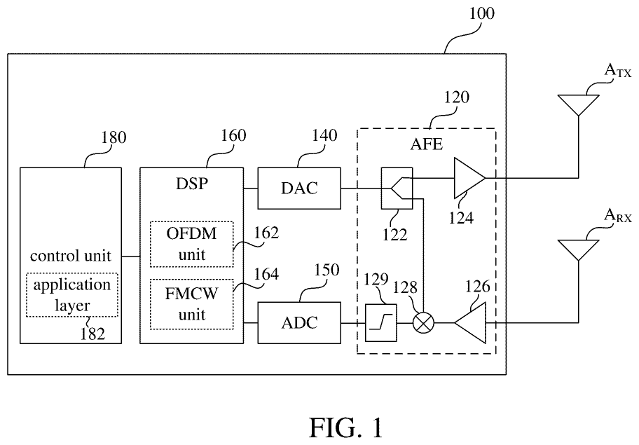

Reference is made to FIG. 1, which is a schematic diagram illustrating a WiFi radar communication circuit 100 according to some embodiments of the present disclosure. The WiFi radar communication circuit 100, in one embodiment, shares hardware components with a typical WiFi transceiver circuit. This allows it to use the WiFi transceiver's functionality, for example, to produce antenna scanning signals. Alongside transceiving WiFi communication packets, the WiFi radar communication circuit 100 is also capable of transmitting radar frames and receiving the resulting reflection echoes. For instance, the WiFi radar communication circuit 100 might use a common portion of its front-end for both WiFi and radar transceiving tasks, while employing separate digital-end circuits for processing WiFi packets and radar frames independently.

The WiFi radar communication circuit 100 can be applied in scenarios such as human presence sensing and motion detection (e.g., smart homes, detecting if someone is in the house via Wi-Fi signals), health monitoring, gesture control (e.g., contactless control, operating smart devices with gestures), or smart surveillance systems (e.g., home security, detecting abnormal movements or intruders).

In the embodiment shown in FIG. 1, the WiFi radar communication circuit 100 includes an analog front-end (AFE) circuit 120, a digital-to-analog converter (DAC) 140, an analog-to-digital converter (ADC) 150, a digital signal processor (DSP) 160, and a control unit 180. It should be particularly noted that various hardware structures can be used to implement the WiFi radar communication circuit 100. FIG. 1 illustrates one of the possible circuit architectures, but the present disclosure is not limited to the hardware architecture shown in FIG. 1.

The analog front-end circuit 120 is coupled to a transmitting antenna A_{TX} and a receiving antenna A_{RX}. In this embodiment, the analog front-end circuit 120 may include a signal coupler 122, a power amplifier 124, a low noise amplifier (LNA) 126, a mixer 128, and a filter 129. The analog front-end circuit 120 is configured to control the transmitting antenna A_{TX} and the receiving antenna A_{RX} to operate on a WiFi communication band or a radar transceiving band. The power amplifier 124 is configured to provide gain for signals transmitted by the antenna. The low noise amplifier 126 is configured to enhance signals received by the antenna and improve sensitivity. The mixer 128 is configured to change the frequency of the received antenna signals. The filter 129 is configured to regulate or select the signal frequency band to pass through.

For example, the WiFi communication band can cover wireless communication bands around 2.4 GHz, 5 GHZ, and 6 GHz; the radar transceiving band can cover, for example, the wireless communication band from 5.725 GHz to 5.875 GHz. In some embodiments, the radar transceiving band used by the WiFi radar communication circuit 100 may have some degree of overlap with general WiFi communication bands. Therefore, when the WiFi radar communication circuit 100 transceives radar frames, it may be subject to interference from other WiFi signal sources or the surrounding environment.

The digital-to-analog converter 140 is coupled between the digital signal processor 160 and the analog front-end circuit 120, and is configured to convert digital signals provided by the digital signal processor 160 into analog signals. The analog-to-digital converter 150 is coupled between the analog front-end circuit 120 and the digital signal processor 160, and is configured to convert analog signals provided by the analog front-end circuit 120 into digital signals.

The digital signal processor 160 is configured to perform digital processing of transmitted or received signals, such as processing information like Channel State Information (CSI), Time of Flight (ToF), and Phase Difference. In some embodiments, the digital signal processor 160 includes an Orthogonal Frequency-Division Multiplexing (OFDM) unit 162 configured to perform digital processing of WiFi communication packets, and the digital signal processor 160 also includes a Frequency Modulated Continuous Wave (FMCW) unit 164 configured to perform digital processing of radar frames.

The control unit 180 can be configured to execute software instructions (e.g., algorithms, control methods, etc.) of an application layer 182. The control unit 180 can be implemented by a processor, a microcontroller (MCU), an application-specific integrated circuit (ASIC), or a field-programmable gate array (FPGA).

To ensure the accuracy of the radar detection function of the WiFi radar communication circuit 100 and to avoid excessive power consumption, the WiFi radar communication circuit 100 is configured in advance to transmit and receive a certain number of effective radar frames within a certain operating cycle.

For example, each operating cycle can be 1 second, and the WiFi radar communication circuit 100 is configured in advance to transmit and receive 6 effective radar frames every 1 second, and it means that a target number of frames per second equals to 6. In some embodiments of the disclosure, while the WiFi radar communication circuit 100 transmitting a radar frame, the WiFi radar communication circuit 100 can detect whether the radar frame is subject to interference, and automatically transmit additional radar frames (e.g., retry radar frames) based on the interference situation to make up for the target number of frames.

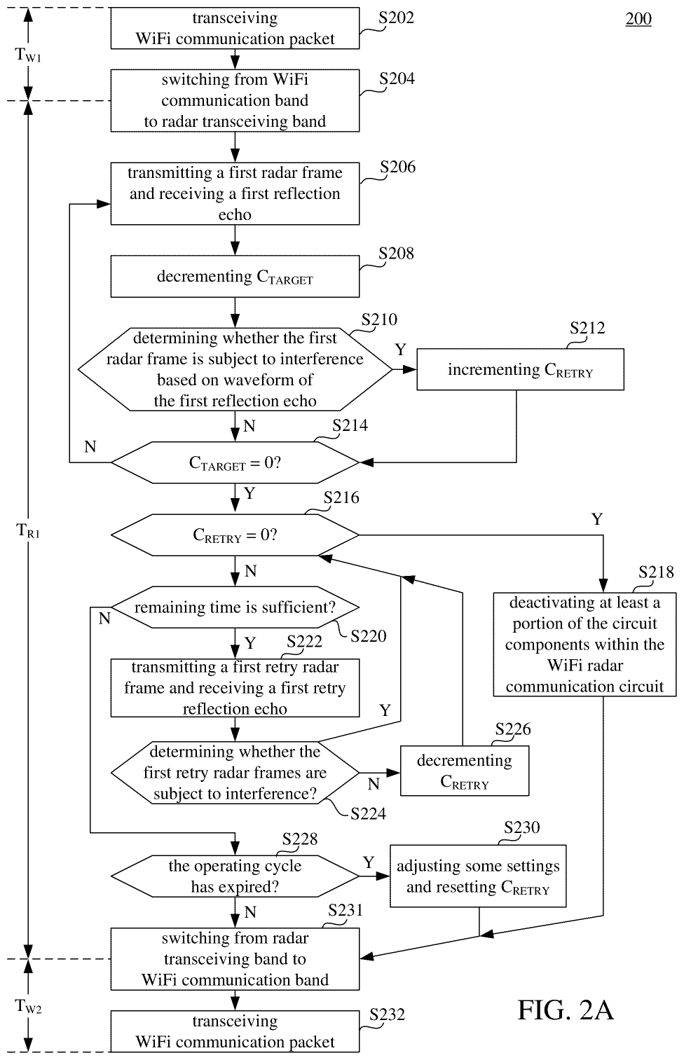

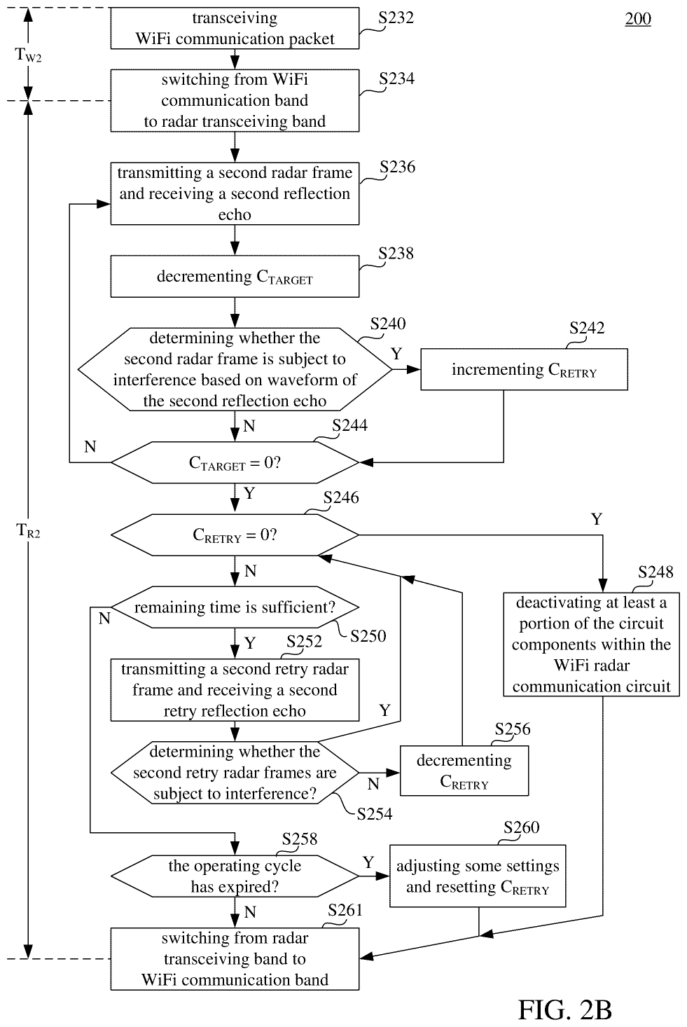

Reference is further made to FIG. 2A and FIG. 2B. FIG. 2A and FIG. 2B illustrate a flowchart of a WiFi radar control method 200 according to some embodiments of the present disclosure. Through the WiFi radar control method 200, when a radar frame is determined to be subject to interference, retry radar frames can be automatically transmitted in one or more radar transceiving slots based on the interference situation, thereby making up for the target number of frames as much as possible.

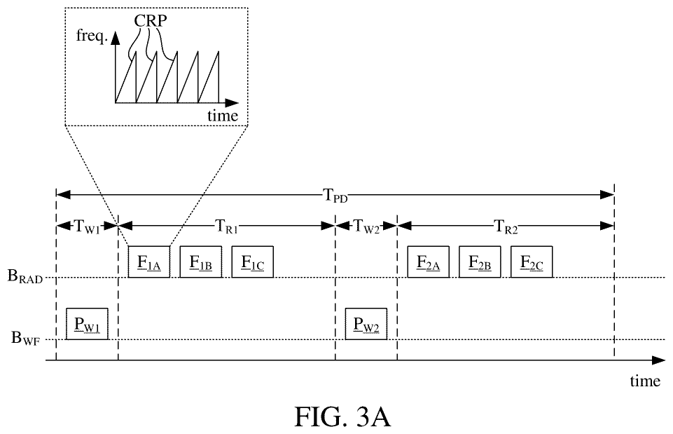

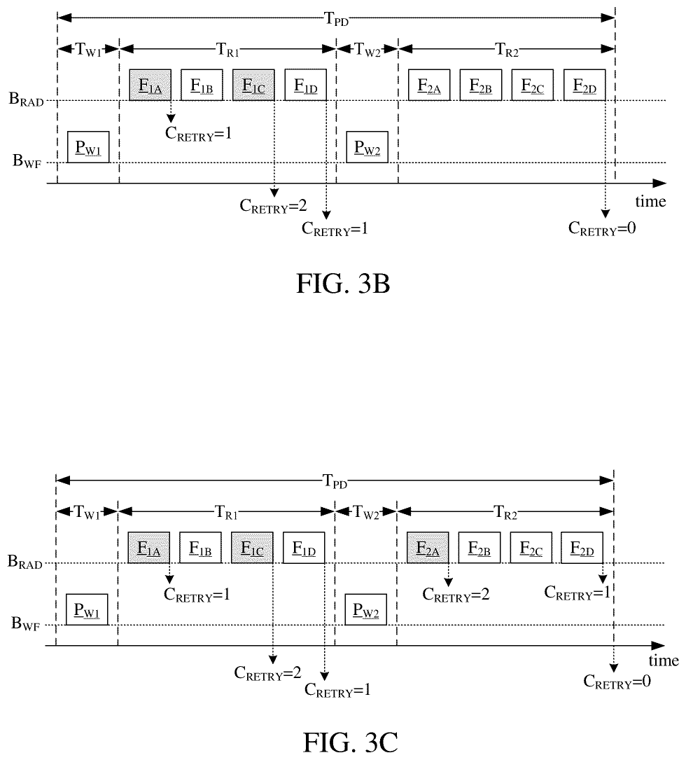

Reference is further made to FIG. 3A, which illustrates a schematic diagram in a first embodiment where radar frames in a first radar transceiving slot T_{R1} and a second radar transceiving slot T_{R2} do not encounter interference.

As shown in FIG. 3A, it is assumed that each operating cycle T_{PD} of the WiFi radar communication circuit 100 is 1 second. Each operating cycle T_{PD} includes a first WiFi communication slot T_{W1}, a first radar transceiving slot T_{R1}, a second WiFi communication slot T_{W2}, and a second radar transceiving slot T_{R2}. In this embodiment, the sum of the first WiFi communication slot T_{W1} and the first radar transceiving slot T_{R1} is 500 milliseconds (ms), and the sum of the second WiFi communication slot T_{W2} and the second radar transceiving slot T_{R2} is 500 milliseconds (ms). The length of the operating cycle T_{PD} is greater than the length of the first radar transceiving slot T_{R1} and also greater than the length of the second radar transceiving slot T_{R2}.

It should be noted that the embodiment shown in FIG. 3A is a timing diagram where the WiFi radar communication circuit 100 alternately operates in two modes, such as WiFi communication function and radar detection function. However, the present disclosure is not limited to this. If the WiFi radar communication circuit 100 operates the radar detection function alone, the first WiFi communication slot T_{W1} and the second WiFi communication slot T_{W2} can be omitted. In this case, the first radar transceiving slot T_{R1} would be 500 milliseconds (ms), and the second radar transceiving slot T_{R2} would be 500 milliseconds (ms). Furthermore, if the WiFi radar communication circuit 100 operates the radar detection function alone, steps S202, S204, S231, S232, S234, and S261 in the WiFi radar control method 200 in FIG. 2A and FIG. 2B can be omitted.

As shown in FIG. 1, FIG. 2A, and FIG. 3A, firstly, the WiFi radar communication circuit 100 executes step S202, for transceiving WiFi communication packets P_{W1} on the WiFi communication band B_{WF} during the first WiFi communication slot T_{W1}. Then, when the first WiFi communication slot T_{W1} ends and the first radar transceiving slot T_{R1} begins, step S204 is executed, switching the (operation of the) WiFi radar communication circuit 100 from the WiFi communication band B_{WF} to the radar transceiving band BRAD.

Next, in the first radar transceiving slot T_{R1}, step S206 is executed, transmitting a first radar frame F_{1A} and receiving a first reflection echo corresponding to the first radar frame F_{1A}.

Then, in step S208, the control unit 180 of the WiFi radar communication circuit 100 decrements a target frame count C_{TARGET}.

In this embodiment, because it is assumed that the target number of frames per operating cycle (e.g., per second) is 6, in this example, the target frame count C_{TARGET} for this first radar transceiving slot T_{R1} is initially set to 3 (out of a total target of 6 for the operating cycle). When the transmission of the first radar frame F_{1A} is completed, the target frame count C_{TARGET} is decremented from 3 to 2 through step S208.

Next, step S210 is executed, determining whether the first radar frame F_{1A} is subject to interference based on the waveform of the first reflection echo received after the transmission of the first radar frame F_{1A}.

In some embodiments, the plurality of first radar frames F_{1A}, F_{1B}, and F_{1C} shown in FIG. 3A are multiple Frequency Modulated Continuous Wave (FMCW) radar frames, each FMCW radar frame includes multiple linear frequency sweep signals (e.g., chirp signals). As shown in FIG. 3A, the first radar frame F_{1A} includes multiple linear frequency sweep signals CRP.

In some embodiments, determining whether the first radar frame F_{1A} is subject to interference in step S210 mentioned above is performed based on the difference between the waveform of the first reflection echo corresponding to the first radar frame F_{1A} and the linear frequency sweep signals CRP.

Generally, if the first radar frame F_{1A} is not subject to signal interference, the waveform of the first reflection echo (which will have a certain delay or phase difference compared to the linear frequency sweep signals CRP of the first radar frame F_{1A}) will retain a waveform similar to the linear frequency sweep signals CRP.

On the other hand, if the first radar frame F_{1A} is subject to the signal interference, the waveform of the first reflection echo will significantly deviate from the waveform of the linear frequency sweep signals CRP in the original first radar frame F_{1A}, for example, the first reflection echo may have jitter or noise at different frequencies. Therefore, when the difference between the waveform of the first reflection echo corresponding to the first radar frame F_{1A} and the waveform of the linear frequency sweep signals CRP is too large (e.g., greater than 20%), it can be determined that the first radar frame F_{1A} is subject to interference.

Aforesaid embodiment regarding whether the first radar frame F_{1A} is subject to interference is based on the difference between the waveform of the first reflection echo and the waveform of the linear frequency sweep signals CRP, but the disclosure is not limited to this. In other embodiments, the control unit 180 of the WiFi radar communication circuit 100 can also determine whether a radar frame is subject to interference based on spectrum analysis (if there are additional spectral components, it may indicate interference), beat frequency analysis (if there are additional beat frequencies, it may indicate interference), Channel State Information (CSI) detection, or autocorrelation function detection.

In the example shown in FIG. 3A, it is assumed that the first radar frames F_{1A}, F_{1B}, and F_{1C} are not subject to interference. In this case, step S212 is not executed, and the retry count C_{RETRY} remains at its initial value of zero.

Next, step S214 is executed, determining whether the target frame count C_{TARGET} has reached zero (at this point, only the first radar frame FA has been transmitted, and the target frame count C_{TARGET} is 2, not yet zero), so the method returns to step S206.

Thus, steps S206 to S214 are repeated to transmit the subsequent first radar frame F_{1B}. Details of these steps S206 to S214 have been described above and will not be repeated here. When step S214 is executed for the second time (at this point, two first radar frames FIA and FB have been transmitted, and the target frame count C_{TARGET} is 1, not yet zero), the method returns to step S206 again.

Thus, steps S206 to S214 are repeated again to transmit another subsequent first radar frame Fic. Details of these steps S206 to S214 have been described above and will not be repeated here. When step S214 is executed for the third time (at this point, three first radar frames F_{1A}, F_{1B}, and F_{1C} have been transmitted, and the target frame count C_{TARGET} has reached zero), the method proceeds to step S216.

In the above steps, because it is assumed in the example shown in FIG. 3A that the first radar frames F_{1A}, F_{1B}, and F_{1C} are not subject to interference, the retry count C_{RETRY} remains zero. In this embodiment, the control unit 180 of the WiFi radar communication circuit 100 executes step S216, determining whether the retry count C_{RETRY} is zero. At this time, the retry count C_{RETRY} is determined to be zero, so step S218 can be executed. Step S218 involves deactivating at least a portion of the circuit components within the WiFi radar communication circuit 100 early, following the completed transmission of the first radar frame F_{1C} and reception of its corresponding first reflection echo. These components remain deactivated until the beginning of the second WiFi communication slot T_{W2}, at which point they are reawakened.

Step S218 can deactivate one or more circuit components among the analog front-end circuit 120, the digital-to-analog converter 140, the analog-to-digital converter 150, and the digital signal processor 160 in the WiFi radar communication circuit 100 shown in FIG. 1, thereby saving power consumption caused by these circuit components.

Next, when the first radar transceiving slot T_{R1} ends and the second WiFi communication slot T_{W2} begins, step S231 is executed, switching the operation of the WiFi radar communication circuit 100 from the radar transceiving band BRAD to the WiFi communication band B_{WF}. Then, step S232 can be executed to transmit WiFi communication packet P_{W2}.

Subsequently, upon entering the second WiFi communication slot T_{W2}, reference is made to FIG. 1, FIG. 2B, and FIG. 3A. The sequence of steps S234 to S261, illustrated in FIG. 2B for the operations within the second radar transceiving slot T_{R2}, are similar to steps S204 to S231 shown in FIG. 2A (which pertain to the first radar transceiving slot T_{R1}). The primary distinction is that the steps S234 to S261 in FIG. 2B are specific to the second radar transceiving slot T_{R2}, occurring after the first radar transceiving slot T_{R1}.

Step S234 is executed, for switching the WiFi radar communication circuit 100 from the WiFi communication band B_{WF} to the radar transceiving band BRAD. Then, in the second radar transceiving slot T_{R2}, step S236 is executed, for transmitting a second radar frame F_{2A} and receiving a second reflection echo corresponding to the second radar frame F_{2A}. Next, in step S238, the control unit 180 of the WiFi radar communication circuit 100 decrements the target frame count C_{TARGET} (from an initial value of 3 to 2 for this slot). Then, step S240 is executed, for determining whether the second radar frame F_{2A} is subject to interference based on the waveform of the second reflection echo received after the transmission of the second radar frame F_{2A}.

In some embodiments, the second radar frames F_{2A}, F_{2B}, and F_{2C} shown in FIG. 3A are multiple FMCW radar frames, each FMCW radar frame includes multiple linear frequency sweep signals CRP (e.g., chirp signals).

In some embodiments, determining whether the second radar frame F_{2A} is subject to interference in step S240 mentioned above is performed based on the difference amount between the waveform of the second reflection echo corresponding to the second radar frame F_{2A} and the linear frequency sweep signals CRP.

In the example shown in FIG. 3A, it is assumed that the second radar frames F_{2A}, F_{2B}, and F_{2C} are not subject to interference. In this case, step S242 is not executed, and the retry count C_{RETRY} remains at its initial value of zero.

Next, step S244 is executed, for determining whether the target frame count C_{TARGET} has reached zero (at this point, the target frame count C_{TARGET} is 2, not yet zero), so the method returns to step S236.

Thus, steps S236 to S244 are repeated to transmit the subsequent second radar frames F_{2B} and F_{2C}. Details of these steps S236 to S244 have been described above and will not be repeated here. When step S244 is executed for the third time (at this point, three second radar frames F_{2A}, F_{2B}, and F_{2C} have been transmitted, and the target frame count C_{TARGET} has reached zero), the method proceeds to step S246, determining whether the retry count C_{RETRY} is zero.

At this time, the retry count C_{RETRY} has been determined to be zero, so step S248 is executed. After the transmission of the second radar frame F_{2C} and the reception of its second reflection echo are completed, at least a portion of the circuit components in the WiFi radar communication circuit 100 are deactivated early. These components remain deactivated until a beginning of the next WiFi communication slot, at which point they are reawakened. When the second radar transceiving slot T_{R2} ends, step S261 is executed, switching the operation of the WiFi radar communication circuit 100 from the radar transceiving band BRAD to the WiFi communication band B_{WF}.

In the first embodiment of FIG. 3A described above, when the target number of radar frames is completed without interference, a portion of the circuit components in the WiFi radar communication circuit 100 can be deactivated early, achieving the effect of energy saving.

Reference is further made to FIG. 3B, which is a schematic diagram illustrating a second embodiment where some radar frames in the first radar transceiving slot T_{R1} encounter interference, and radar frames in the second radar transceiving slot T_{R2} do not encounter interference.

Compared to the example in FIG. 3A (where first radar frames F_{1A}, F_{1B}, F_{1C} and second radar frames F_{2A}, F_{2B}, F_{2C} are not subject to interference), in the second embodiment of FIG. 3B, it is assumed that two first radar frames FIA and F_{1C} in the first radar transceiving slot T_{R1} encounter interference.

Reference is made to FIG. 1, FIG. 2A, and FIG. 3B, during the steps of sequentially transmitting three first radar frames F_{1A}, FIB, and F_{1C} in the first radar transceiving slot T_{R1}, step S212 is executed twice, for the first radar frame F_{1A} and the first radar frame F_{1C} respectively, causing the retry count C_{RETRY} to be incremented from an initial value of 0 to 1, and then from 1 to 2. Therefore, in the example of FIG. 3B, when the first radar frames F_{1A}, F_{1B}, and F_{1C} are completed, the target frame count C_{TARGET} is 0 and the retry count C_{RETRY} is 2.

Next, step S216 is executed, determining whether the retry count C_{RETRY} is zero. Since the retry count C_{RETRY} is 2, step S220 is executed, for determining whether the first remaining time of the first radar transceiving slot TRI is sufficient. At this time, the first remaining time of the first radar transceiving slot T_{R1} is still sufficient to accommodate one radar frame. Therefore, the method proceeds to step S222, transmitting a first retry radar frame F_{1D} in the first radar transceiving slot T_{R1}, and receiving a first retry reflection echo corresponding to the first retry radar frame F_{1D}.

Step S224 is executed, for determining whether the first retry radar frame F_{1D} is subject to interference based on the waveform of the first retry reflection echo. At this time, in the embodiment of FIG. 3B, it is assumed that the first retry radar frame F_{1D} is not subject to interference, so step S226 is executed, decrementing the retry count C_{RETRY} from 2 to 1.

Then, the method returns to step S216, and it is determined that the retry count C_{RETRY} is not yet zero. Step S220 is executed again, for determining whether the first remaining time of the first radar transceiving slot T_{R1} is sufficient. At this time, because the first remaining time of the first radar transceiving slot T_{R1} is no longer sufficient to accommodate another retry radar frame, the method proceeds to step S228, for determining whether the operating cycle T_{PD} has expired. At this time, as shown in FIG. 3B, just after the first retry radar frame F_{1D} is completed, the operating cycle T_{PD} has not yet expired. The method proceeds to step S231, for switching the (operation of the) WiFi radar communication circuit 100 from the radar transceiving band BRAD to the WiFi communication band B_{WF}. Then, step S232 can be executed to transmit WiFi communication packet P_{W2}.

On the other hand, if it is determined that the operating cycle T_{PD} has expired, step S230 can be executed to adjust the settings of the WiFi radar communication circuit 100 and reset the retry count C_{RETRY} to zero.

Next, reference is made to FIG. 1, FIG. 2B, and FIG. 3B, during the sequential transmission of three second radar frames F_{2A}, F_{2B}, and F_{2C} in the second radar transceiving slot T_{R2} (repeating steps S236, S238, S240, and S244), since the second radar frames F_{2A}, F_{2B}, and F_{2C} are not subject to interference in this example, the retry count C_{RETRY} remains 1 (accumulated in the first radar transceiving slot T_{R1} and carried over to the second radar transceiving slot T_{R2}).

Next, after determining in step S246 that the retry count C_{RETRY} is not yet zero, the method proceeds to step S250, for determining whether the second remaining time of the second radar transceiving slot T_{R2} is sufficient. In this case, if the second remaining time of the second radar transceiving slot T_{R2} is determined to be sufficient to accommodate one radar frame. Therefore, the method proceeds to step S252, for transmitting a second retry radar frame F_{2D} in the second radar transceiving slot T_{R2}, and receiving a second retry reflection echo corresponding to the second retry radar frame F_{2D}. Then, step S254 is executed for determining whether the second retry radar frame F_{2D} is subject to interference based on the waveform of the second reflection echo. At this time, because it is determined that the second retry radar frame F_{2D} is not subject to interference, step S256 is executed, for decrementing the retry count C_{RETRY} from 1 to 0. Conversely, if it is determined that the second retry radar frame F_{2D} is subject to interference, the retry count C_{RETRY} will be maintained.

At this point, returning to step S246, if the retry count C_{RETRY} has reached zero, the method proceeds to step S248 to deactivate a portion of the circuit components in the WiFi radar communication circuit 100. When the second radar transceiving slot T_{R2} ends, step S261 is executed, switching the operation of the WiFi radar communication circuit 100 from the radar transceiving band BRAD to the WiFi communication band B_{WF}.

As detailed in the second embodiment of FIG. 3B, the first radar transceiving slot T_{R1} and the second radar transceiving slot T_{R2} both utilize the same retry count C_{RETRY} to determine whether to transmit retry radar frames (e.g., the first retry radar frame F_{1D} and the second retry radar frame F_{2D}). Consider a situation where two radar frames encounter interference in TRI. If only one retry frame (e.g., F_{1D}) can be accommodated within the remaining time of the first radar transceiving slot T_{R1}, then in this case, the second radar transceiving slot T_{R2}, which follows the first radar transceiving slot T_{R1}, can be used to continue the retry frame transmission (e.g., the second retry radar frame F_{2D}). The WiFi radar control method 200, through such mechanisms, aims to ensure that each operating cycle T_{PD} completes its target of, for example, six effective (uninterfered) frames, thereby improving the overall stability and precision of radar detection per cycle.

It is noted that the number of radar transceiving slots included in each operating cycle T_{PD} in the present disclosure (2 in the embodiment), the target number of frames for each radar transceiving slot (3 in the embodiment), and the length of the remaining time for each radar transceiving slot (capable of accommodating 1 retry radar frame in the embodiment) are not limited to the above-mentioned embodiments. The above embodiments are provided as examples for ease of explanation and can be adjusted according to practical applications.

Reference is further made to FIG. 3C, which is a schematic diagram illustrating a third embodiment where some radar frames in the first radar transceiving slot T_{R1} and the second radar transceiving slot T_{R2} encounter interference.

In the third embodiment of FIG. 3C, it is assumed that two first radar frames F_{1A} and F_{1C} in the first radar transceiving slot T_{R1} are subject to interference, and one second radar frame F_{2A} in the second radar transceiving slot T_{R2} is subject to interference.

As shown in FIG. 30, when the first radar transceiving slot T_{R1} is completed (corresponding to steps S202 to S231 shown in FIG. 2A), the retry count C_{RETRY} is 1 at this time.

Reference is made to FIG. 1, FIG. 2B, and FIG. 3B. During the sequential transmission of three second radar frames F_{2A}, F_{2B}, and F_{2C} in the second radar transceiving slot T_{R2} (repeating steps S236, S238, S240, and S244), step S240 determines that the second radar frame F_{2A} is subject to interference. Accordingly, step S242 is executed for incrementing the retry count C_{RETRY} from 1 to 2. The other two second radar frames F_{2B} and F_{2C} are not subject to interference.

Next, the process proceeds to step S246, and it is determined that the retry count C_{RETRY} is not yet zero. Accordingly, step S250 is executed, determining whether the second remaining time of the second radar transceiving slot T_{R2} is sufficient. In this case, the second remaining time of the second radar transceiving slot T_{R2} is still sufficient to accommodate one radar frame. Therefore, the process proceeds to step S252 for transmitting a second retry radar frame F_{2D} in the second radar transceiving slot T_{R2}, and receiving a second retry reflection echo corresponding to the second retry radar frame F_{2D}. Then, step S254 is executed for determining whether the second retry radar frame F_{2D} is subject to interference based on the waveform of the second reflection echo. In this case, because it is determined that the second retry radar frame F_{2D} is not subject to interference, step S256 is executed for decrementing the retry count C_{RETRY} from 2 to 1.

The method returns to step S246, and it is determined that the retry count C_{RETRY} is not yet zero. Step S250 is executed again. In this case, it is determined that the second remaining time of the second radar transceiving slot T_{R2} is no longer sufficient to accommodate another radar frame. The method proceeds to step S258, determining whether the operating cycle T_{PD} has expired. Since this is the last radar transceiving slot in the operating cycle T_{PD} (i.e., the second radar transceiving slot T_{R2}), it can be determined that the operating cycle T_{PD} has expired, and there is no next radar transceiving slot. This indicates that the environmental interference is relatively severe, and transmitting retry radar frames as much as possible within one operating cycle T_{PD} still cannot meet (or is insufficient to meet) the target number of frames (i.e., 6) for each operating cycle T_{PD}. The control unit 180 of the WiFi radar communication circuit 100 executes step S260 to adjust the settings of the WiFi radar communication circuit 100 and reset the retry count C_{RETRY} to zero.

For example, aforementioned adjustment of the settings of the WiFi radar communication circuit 100 may include increasing the transmission signal gain by the power amplifier 124, adjusting the sensitivity of the low noise amplifier 126, adjusting the settings of the filter 129, or reducing the target number of frames.

Step S260 involves periodically resetting the retry count C_{RETRY} to zero. This periodic reset is crucial to prevent the continuous accumulation of the retry count C_{RETRY}, a situation that could render the retry mechanism ineffective. For instance, if the retry count C_{RETRY} were allowed to accumulate indefinitely, an operating cycle T_{PD} experiencing significant noise might accrue a large retry count. This large, carried-over count would then erroneously compel subsequent operating cycles, even those without noise, to transmit unnecessary retry radar frames. This periodic reset avoids this scenario.

In aforementioned third embodiment of FIG. 3C, the retry count C_{RETRY} is shared by the first radar transceiving slot T_{R1} and the second radar transceiving slot T_{R2} as a common reference to control whether to transmit the at least one retry radar frame (e.g., the first retry radar frame FID and the second retry radar frame F_{2D}). Furthermore, when the target number of frames cannot be met even when the operating cycle T_{PD} expires, appropriate adjustments can be made through step S260, and the retry count C_{RETRY} can be reset to zero.

In the above embodiments, the WiFi radar control method 200 provides a mechanism where multiple radar transceiving slots share remaining time with each other to transmit retry radar frames, enabling each operating cycle T_{PD} to achieve the target number of frames as much as possible. This can improve the stability and accuracy of radar detection in each operating cycle T_{PD}.

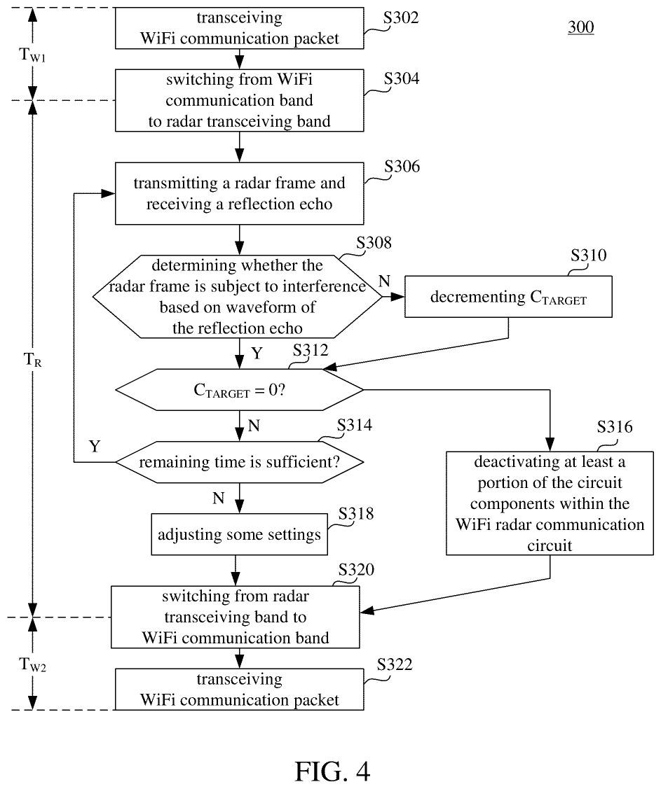

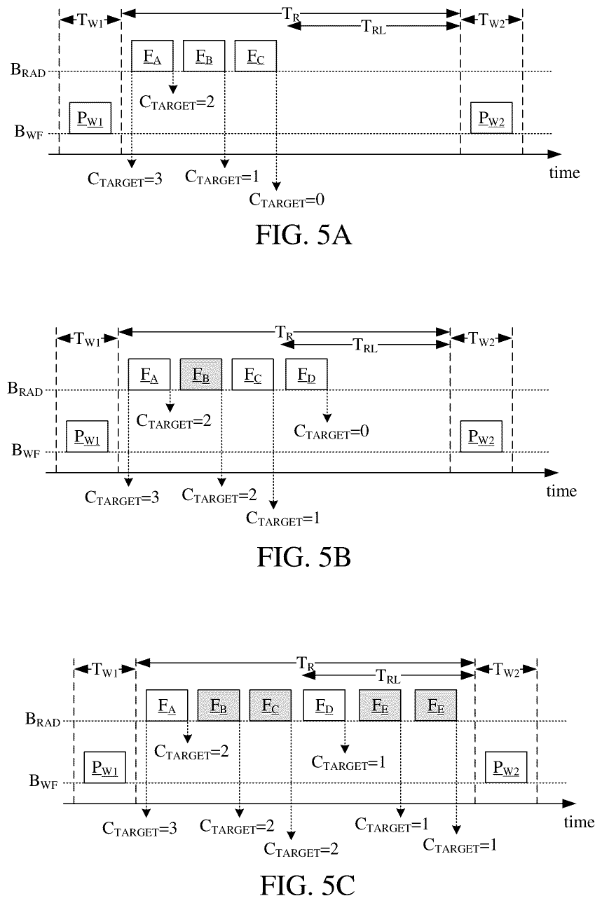

The disclosure is not limited to the WiFi radar control method 200 shown in FIG. 2A and FIG. 2B. Reference is further made to FIG. 4 and FIG. 5A. FIG. 4 is a flowchart diagram illustrating a WiFi radar control method 300 according to some embodiments of the present disclosure. FIG. 5A is a schematic diagram illustrating a fourth embodiment where radar frames in a radar transceiving slot TR do not encounter interference.

As shown in FIG. 1, FIG. 4, and FIG. 5A, first, the WiFi radar communication circuit 100 executes step S302, for transceiving WiFi communication packets P_{W1} on the WiFi communication band B_{WF} during the first WiFi communication slot T_{W1}. Then, when the first WiFi communication slot T_{W1} ends and the radar transceiving slot TR begins, step S304 is executed, switching the (operation of the) WiFi radar communication circuit 100 from the WiFi communication band B_{WF} to the radar transceiving band BRAD.

Next, in the radar transceiving slot TR, the control unit 180 of the WiFi radar communication circuit 100 executes step S306, transmitting a radar frame FA and receiving a reflection echo corresponding to the radar frame FA.

Then, in step S308, the control unit 180 of the WiFi radar communication circuit 100 determines whether the radar frame FA is subject to interference based on the waveform of the reflection echo of the radar frame FA.

In this case, step S308 determines that the radar frame FA is not subject to interference, so the method proceeds to step S310 for decrementing the target frame count C_{TARGET} from a predicted value of 3 to 2, which means that one effective radar frame FA has been transmitted.

Next, the control unit 180 executes step S312, for determining whether the target frame count C_{TARGET} has reached zero. In this case, it is determined that the target frame count C_{TARGET} has not yet reached zero, so the method proceeds to step S314, for determining whether the remaining time of the radar transceiving slot TR is sufficient. In this case, it is determined that the remaining time of the radar transceiving slot TR is still sufficient, so the method proceeds to step S306, and it continues to transmit another radar frame FB in the radar transceiving slot TR.

Similarly, when the transmission of radar frame FB and radar frame Fc is completed, the target frame count C_{TARGET} is sequentially decremented to 1 and then to 0. In this case, step S312 determines that the target frame count C_{TARGET} has reached zero, so the method proceeds to step S316, deactivating at least a portion of the circuit components in the WiFi radar communication circuit 100 early. These components remain deactivated until the beginning of the second WiFi communication slot T_{W2}, at which point they are reawakened.

Step S316 can deactivate one or more circuit components among the analog front-end circuit 120, the digital-to-analog converter 140, the analog-to-digital converter 150, and the digital signal processor 160 in the WiFi radar communication circuit 100 shown in FIG. 1, thereby saving power consumption caused by these circuit components.

Next, step S320 is executed, switching the operation of the WiFi radar communication circuit 100 from the radar transceiving band BRAD to the WiFi communication band B_{WF}. In the second WiFi communication slot T_{W2}, step S322 is executed, transceiving WiFi communication packet P_{W2}.

Reference is made to FIG. 5B, which illustrates a schematic diagram in a fifth embodiment where some radar frames in the radar transceiving slot TR are subject to interference.

As shown in FIG. 1, FIG. 4, and FIG. 5B, the WiFi radar communication circuit 100 transmits radar frame FA, which is not subject to interference. Therefore, the process proceeds to step S310, for decrementing the target frame count C_{TARGET} from the predicted value of 3 to 2, which means that one effective radar frame FA has been transmitted.

Next, the WiFi radar communication circuit 100 transmits radar frame FB, and step S308 determines that radar frame FB is subject to interference. Therefore, the target frame count C_{TARGET} is not decremented and remains at 2.

Regarding whether radar frame FB is subject to interference, it can be determined based on the difference between the waveform of the reflection echo of radar frame FB and the linear frequency sweep signals included in radar frame FB, but the present disclosure is not limited to this. In other embodiments, the control unit 180 of the WiFi radar communication circuit 100 can also determine whether a radar frame is subject to interference based on spectrum analysis, beat frequency analysis, Channel State Information detection, or autocorrelation function detection.

Next, the WiFi radar communication circuit 100 transmits radar frame Fc, and step S308 determines that radar frame Fc is not subject to interference. Step S310 is executed for decrementing the target frame count C_{TARGET} from 2 to 1.

Next, the method proceeds to step S314 for determining whether the remaining time of the radar transceiving slot TR is sufficient. In this case, it is determined that the remaining time of the radar transceiving slot TR is still sufficient (as shown in FIG. 5B, the radar transceiving slot TR includes a retransmission time TRL to accommodate additional radar frames), so the method proceeds to step S306, and it continues to transmit another radar frame F_{D} in the radar transceiving slot TR. When step S308 determines that radar frame F_{D} is not subject to interference, step S310 is executed, for decrementing the target frame count C_{TARGET} from 1 to 0.

After determining in step S312 that the target frame count C_{TARGET} has reached zero, step S316 is executed, for deactivating at least a portion of the circuit components in the WiFi radar communication circuit 100 early. These components remain deactivated until the beginning of the second WiFi communication slot T_{W2}, at which point they are reawakened.

Next, step S320 is executed, switching the operation of the WiFi radar communication circuit 100 from the radar transceiving band BRAD to the WiFi communication band B_{WF}. In the second WiFi communication slot T_{W2}, step S322 is executed for transceiving WiFi communication packet P_{W2}.

Reference is made to FIG. 50, which is a schematic diagram illustrating a sixth embodiment where some radar frames in the radar transceiving slot TR encounter interference.

As shown in FIG. 1, FIG. 4, and FIG. 50, first, the WiFi radar communication circuit 100 transmits radar frame FA, which is not subject to interference. Therefore, the process proceeds to step S310 for decrementing the target frame count C_{TARGET} from the predicted value of 3 to 2, which means that one effective radar frame FA has been transmitted.

Next, the WiFi radar communication circuit 100 sequentially transmits the radar frame FB and the radar frame Fc. In both instances, step S308 determines that the radar frame FB and the radar frame Fc are subject to interference. Therefore, the target frame count C_{TARGET} is not decremented and remains at 2.

Next, in step S312, it is determined that the target frame count C_{TARGET} has not yet reached zero. The method proceeds to step S314 for determining whether the remaining time of the radar transceiving slot TR is sufficient. At this time, it is determined that the remaining time of the radar transceiving slot TR is still sufficient, so the method proceeds to step S306, it continues to transmit another radar frame F_{D} in the radar transceiving slot TR. When step S308 determines that radar frame F_{D} is not subject to interference, step S310 is executed, decrementing the target frame count C_{TARGET} from 2 to 1.

After determining in step S312 that the target frame count C_{TARGET} has not yet reached zero, the WiFi radar communication circuit 100 sequentially transmits a radar frame F_{E} and a radar frame F_{F}. In both instances, step S308 determines that the radar frame F_{E} and the radar frame F_{F} are subject to interference. Therefore, the target frame count C_{TARGET} is not decremented and remains at 1.

In step S312, it is determined that the target frame count C_{TARGET} has not yet reached zero. The method proceeds to step S314 for determining whether the remaining time of the radar transceiving slot TR is sufficient. In this case, step S314 determines that the remaining time of the radar transceiving slot TR is no longer sufficient to accommodate another radar frame. The control unit 180 executes step S318 to appropriately adjust the settings of the WiFi radar communication circuit 100. For example, aforementioned appropriate adjustments can include increasing the transmission signal gain by the power amplifier 124, adjusting the sensitivity of the low noise amplifier 126, adjusting the settings of the filter 129, or reducing the target number of frames.

Next, step S320 is executed for switching the operation of the WiFi radar communication circuit 100 from the radar transceiving band BRAD to the WiFi communication band B_{WF}. In the second WiFi communication slot T_{W2}, step S322 is executed for transceiving WiFi communication packet P_{W2}.

In the embodiment of FIG. 4, retransmission of radar frames is performed individually for each radar transceiving slot TR, to meet a predetermined number of effective radar frames as much as possible. When the predetermined number of effective radar frames is completed, at least a portion of the circuit components in the WiFi radar communication circuit 100 can be deactivated early (e.g., FIG. 5A and FIG. 5B) to save energy, and the stability and accuracy of radar detection can be ensured. When the predetermined number of effective radar frames cannot be completed, appropriate adjustments can also be made to the WiFi radar communication circuit 100 (e.g., FIG. 5C).

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A WiFi radar control method, comprising:
in a first radar transceiving slot, sequentially transmitting, by a WiFi radar communication circuit, a plurality of first radar frames, and receiving a plurality of first reflection echoes corresponding to the plurality of first radar frames;
determining, based on waveforms of the plurality of first reflection echoes, whether the plurality of first radar frames are subject to interference;
in response to determining that the plurality of first radar frames are subject to interference, incrementing a retry count; and
in response to the retry count not being zero, transmitting at least one retry radar frame in the first radar transceiving slot or in a second radar transceiving slot subsequent to the first radar transceiving slot.

2. The WiFi radar control method of claim 1, further comprising:
in the first radar transceiving slot, in response to the retry count not being zero, determining whether a first remaining time of the first radar transceiving slot is sufficient;
in response to the first remaining time being sufficient, transmitting a first retry radar frame in the first radar transceiving slot, and receiving a first retry reflection echo corresponding to the first retry radar frame;
determining, based on a waveform of the first retry reflection echo, whether the first retry radar frame is subject to interference; and
in response to determining that the first retry radar frame is not subject to interference, decrementing the retry count.

3. The WiFi radar control method of claim 2, further comprising:
determining whether an operating cycle has expired, wherein a length of the operating cycle is greater than a length of the first radar transceiving slot and greater than a length of the second radar transceiving slot; and
in response to determining that the operating cycle has expired, resetting the retry count to zero.

4. The WiFi radar control method of claim 1, further comprising:
at a beginning of the first radar transceiving slot, switching the WiFi radar communication circuit from a WiFi communication band to a radar transceiving band;
at an end of the first radar transceiving slot, switching the WiFi radar communication circuit from the radar transceiving band to the WiFi communication band; and
transceiving a WiFi communication packet.

5. The WiFi radar control method of claim 1, further comprising:
in the second radar transceiving slot, sequentially transmitting a plurality of second radar frames, and receiving a plurality of second reflection echoes corresponding to the plurality of second radar frames;
determining, based on waveforms of the plurality of second reflection echoes, whether the plurality of second radar frames are subject to interference; and
in response to determining that the plurality of second radar frames are subject to interference, incrementing the retry count.

6. The WiFi radar control method of claim 1, further comprising:
in the second radar transceiving slot, in response to the retry count not being zero, determining whether a second remaining time of the second radar transceiving slot is sufficient;
in response to the second remaining time being sufficient, transmitting a second retry radar frame in the second radar transceiving slot, and receiving a second retry reflection echo corresponding to the second retry radar frame;
determining, based on a waveform of the second retry reflection echo, whether the second retry radar frame is subject to interference; and
in response to determining that the second retry radar frame is not subject to interference, decrementing the retry count.

7. The WiFi radar control method of claim 1, wherein the plurality of first radar frames are a plurality of Frequency Modulated Continuous Wave (FMCW) radar frames, each of the plurality of FMCW radar frames comprises a plurality of linear frequency sweep signals.

8. The WiFi radar control method of claim 7, wherein determining whether the plurality of first radar frames are subject to interference is performed based on a difference amount between waveforms of the plurality of first reflection echoes and the plurality of linear frequency sweep signals.

9. The WiFi radar control method of claim 1, wherein determining whether the plurality of first radar frames are subject to interference is performed based on spectrum analysis, beat frequency analysis, Channel State Information (CSI) detection, or autocorrelation function detection.

10. The WiFi radar control method of claim 1, further comprising:
in response to the retry count being zero, deactivating at least a portion of circuit components in the WiFi radar communication circuit before an end of the first radar transceiving slot or before an end of the second radar transceiving slot.

11. The WiFi radar control method of claim 1, wherein the retry count is shared by the first radar transceiving slot and the second radar transceiving slot as a common reference to control whether to transmit the at least one retry radar frame.

12. A WiFi radar control method, comprising:
in a radar transceiving slot, transmitting, by a WiFi radar communication circuit, a radar frame, and receiving a reflection echo corresponding to the radar frame;
determining, based on a waveform of the reflection echo, whether the radar frame is subject to interference;
in response to determining that the radar frame is not subject to interference, decrementing a target frame count; and
in response to the target frame count not being zero, continuing to transmit another radar frame in the radar transceiving slot.

13. The WiFi radar control method of claim 12, further comprising:
in the radar transceiving slot, in response to the target frame count not being zero, determining whether a remaining time of the radar transceiving slot is sufficient;
in response to determining that the remaining time is sufficient, transmitting the another radar frame in the radar transceiving slot, and receiving another reflection echo corresponding to the another radar frame;
determining, based on a waveform of the another reflection echo, whether the another radar frame is subject to interference; and
in response to determining that the another radar frame is not subject to interference, decrementing the target frame count.

14. The WiFi radar control method of claim 12, further comprising:
at a beginning of the radar transceiving slot, switching the WiFi radar communication circuit from a WiFi communication band to a radar transceiving band;
at an end of the radar transceiving slot, switching the WiFi radar communication circuit from the radar transceiving band to the WiFi communication band; and
transceiving a WiFi communication packet.

15. The WiFi radar control method of claim 12, wherein the radar frame is a Frequency Modulated Continuous Wave (FMCW) radar frame, the FMCW radar frame comprising a plurality of linear frequency sweep signals.

16. The WiFi radar control method of claim 15, wherein determining whether the radar frame is subject to interference is performed based on a difference amount between a waveform of the reflection echo and the plurality of linear frequency sweep signals.

17. The WiFi radar control method of claim 12, wherein determining whether the radar frame is subject to interference is performed based on spectrum analysis, beat frequency analysis, Channel State Information (CSI) detection, or autocorrelation function detection.

18. The WiFi radar control method of claim 12, further comprising:
in response to the target frame count being zero, deactivating at least a portion of circuit components in the WiFi radar communication circuit before an end of the radar transceiving slot.

19. A WiFi radar communication circuit, comprising:
an analog front-end circuit, coupled to a transmitting antenna and a receiving antenna, configured to control the transmitting antenna and the receiving antenna to operate in a WiFi communication band or a radar transceiving band; and
a control unit, coupled to the analog front-end circuit, the control unit configured to:
in a first radar transceiving slot, sequentially transmit, via the analog front-end circuit, a plurality of first radar frames to the transmitting antenna, and receive, from the receiving antenna, a plurality of first reflection echoes corresponding to the plurality of first radar frames;
determine, based on waveforms of the plurality of first reflection echoes, whether the plurality of first radar frames are subject to interference;
in response to determining that the plurality of first radar frames are subject to interference, increment a retry count; and
in response to the retry count not being zero, transmit at least one retry radar frame in the first radar transceiving slot or in a second radar transceiving slot subsequent to the first radar transceiving slot.

20. The WiFi radar communication circuit of claim 19, further comprising:
a digital signal processor, coupled to the control unit;
a digital-to-analog converter, coupled between the digital signal processor and the analog front-end circuit; and
an analog-to-digital converter, coupled between the analog front-end circuit and the digital signal processor,
wherein, in the first radar transceiving slot or the second radar transceiving slot, in response to the retry count being zero, the analog front-end circuit, the digital-to-analog converter, or the analog-to-digital converter is deactivated before an end of the first radar transceiving slot or the second radar transceiving slot.
